(19) United States
(12) Patent Application Publication
(10) Pub. No.: US 2015/0187014 A1
(43) Pub. Date: Jul. 2, 2015

(54) SYSTEM AND METHOD FOR EXPECTATION BASED PROCESSING

(71) Applicant: Hartford Fire Insurance Company, Hartford, CT (US)

(72) Inventors: Isaac D. Adams, Canton, CT (US); Steven J. Fernandes, West Hartford, CT (US); Marc J. Natrillo, Avon, CT (US); Paul Brendan Olson, Hartford, CT (US); Pankaj Prakash, Rocky Hill, CT (US)

(73) Assignee: Hartford Fire Insurance Company, Hartford, CT (US)

(21) Appl. No.: 14/145,165

(22) Filed: Dec. 31, 2013

(51) Int. Cl. G06Q 40/08

(52) U.S. Cl. CPC G06Q 40/08

(57) ABSTRACT

A system for determining insurance pricing information based on telematics data, the system comprising, a processor configured to generate a driver proxy score (DPS) based on a combination of rating variables in a conventional class plan; the processor, configured to receive information associated with telematics data received from a telematics device, wherein the telematics data includes a plurality of risk factors; the processor further configured to determine a driver telematics score (DTS) based on the information associated with the telematics data; the processor further configured to generate an expectation based rating, based on the DPS and the DTS, which measures a variance of the telematics data from the expected value; the processor further configured to update pricing information based on the determined expectation based rating; and a transmitter configured to transmit the updated pricing information to a user device.

### INCORPORATION BY REFERENCE

The following documents are incorporated herein by reference as if fully set forth: U.S. application Ser. No. 14/145,142, titled SYSTEM AND METHOD FOR DETERMINING DRIVER SIGNATURES filed Dec. 31, 2013; U.S. application Ser. No. 14/145,181, titled SYSTEM AND METHOD FOR DESTINATION BASED UNDERWRITING filed Dec. 31, 2013; and U.S. application Ser. No. 14/145,205, titled SYSTEM AND METHOD FOR TELEMATICS BASED UNDERWRITING filed Dec. 31, 2013. Each of the applications shares common inventorship with the present application and are being filed concurrently.

### BACKGROUND

Vehicle insurance is typically comprised of five types of coverage, including liability, collision, personal injury protection, comprehensive and uninsured motorist protection. Each of the coverages may have an agreed upon policy limit or liability to the insurance company. Insurance companies gather use correlative data, or proxies, to determine the risk associated with providing coverage. There are certain driving behaviors that have been statistically linked to higher risk of losses. For example, speeding, excessive braking, or driving while sleepy or intoxicated may be factors that lead to an increased chance of an accident. While in some cases prior incidents are available to an insurance company to make a determination, in many cases, this information is either not available or limited for a new customer. Accordingly, insurance companies use certain driver biographical information as a proxy for these behaviors. Based on historical data, the biographical information might include factors such as age, gender, marital status etc. that are correlated with the loss experience. Examples of general proxies may include the following:
a. Credit rating. Low credit scores may be associated with high risk drivers.
b. Experience. The less experienced you are (often signifying a younger driver) the higher the rates. In some cases until a driver reaches the age of 25, they may be in a high risk category.
c. Occupation. Working from home may qualify for an insurance rate discount due to less expected total mileage driven.
d. Residence. Rates may be higher in urban areas due to expected risk of accidents, theft, and vandalism.
e. Driving record. An individual with a clean driving record may receive lower rates.
f. Timely payment of premiums. Correlative data may suggest this is a trait of a responsible person, which may be associated with lower risk.
g. Marital status. Generally, married drivers, and drivers with families may be expected to be less prone to taking chances.
h. Your type of car. Expensive cars generally equate into higher insurance rates. However, this may be mitigated for a vehicle equipped with safety features like airbags, automatic seat belts and anti-lock brakes.
i. Gender. Generally male drivers may be expected to be riskier drivers than females.

Based on the above, as well as many other factors, insurance companies calculate a risk factor, which essentially translates to the likelihood and severity of a claim. This risk factor is then used to help determine either to provide or deny coverage, and assist in determining the pricing for any coverage that is provided.

However, these proxies are based on the fact that they are correlated to the actual driving behavior and may or may not be a causal factor. For example, persons with a bad credit score may pay a higher premium.

Accordingly, a system and method is proposed to introduce an improved expectation based rating, using telematics data to more accurately assess driver risk.

### SUMMARY

This application relates to an insurance rating methodology that assesses a driver's risk based on telematics data collected on actual driving behavior relative to the expected driving behavior. Drivers are assessed for eligibility for discounts based on the ratio between an expected or known or historical rating versus their actual demonstrated rating. For example, if a driver with a poor driving history who is currently rated as a high risk driver, exhibits average driving behaviors, this driver may actually be eligible for a discount as the demonstrated driving behaviors were on par or not as bad as their expected driving behavior. Conversely, if a driver with a prior excellent driving history exhibits average driving behaviors, then this driver may receive no discount or may even get a surcharge as the driver is exhibiting driving that is worse than expected.

Essentially, this allows an insurer to swap out proxies that are correlated with driving behavior with actual measured driving behavior. The methods described herein allow the insurance company to perform real-time pricing based on the determined telematics data collection period. The methods described herein may allow the insurance company to provide a quote to add an additional car, to replace a car, or to remove a previously covered driver.

A system for determining insurance pricing information based on telematics data, the system comprising, a processor configured to generate a driver proxy score (DPS) based on a combination of rating variables in a conventional class plan; the processor, configured to receive information associated with telematics data received from a telematics device, wherein the telematics data includes a plurality of risk factors; the processor further configured to determine a driver telematics score (DTS) based on the information associated with the telematics data; the processor further configured to generate an expectation based rating, based on the DPS and the DTS, which measures a variance of the telematics data from the expected value; the processor further configured to update pricing information based on the determined expectation based rating; and a transmitter configured to transmit the updated pricing information to a user device.

### BRIEF DESCRIPTION OF THE DRAWINGS

A more detailed understanding may be had from the following description, given by way of example in conjunction with the accompanying drawings wherein:

FIG. 1 shows an example system architecture that may be used for expectation based processing;

FIG. 2 shows a flow diagram for a method for expectation based processing;

FIG. 3 is an example web page for initiating a request for a vehicle insurance quote;

FIG. 4 is an example web page soliciting preliminary information regarding a request for a vehicle insurance quote;

FIG. 5 is an example web page soliciting additional preliminary information regarding a request for a vehicle insurance quote;

FIG. 6 is an example web page soliciting name and address information of the individual requesting a vehicle insurance quote;

FIG. 7 is an example web page soliciting vehicle information regarding a request for a vehicle insurance quote;

FIG. 8 is an example web page soliciting additional vehicle information regarding a request for a vehicle insurance quote;

FIG. 9 is an example web page soliciting driver information regarding a request for a vehicle insurance quote;

FIG. 10 is an example web page soliciting additional driver information regarding a request for a vehicle insurance quote;

FIG. 11 is another example web page soliciting additional driver information regarding a request for a vehicle insurance quote;

FIG. 12 is an example web page soliciting driver history information regarding a request for a vehicle insurance quote;

FIG. 13 is an example web page soliciting a response from the user for registration to TrueLane® telematics program;

FIG. 14 shows three examples of assessing a driver's risk based on telematics data collected on actual driving behavior relative to the expected driving behavior;

FIG. 15 shows an example electronic device that may be used to implement features described herein with reference to FIGS. 1-14; and

FIG. 16 shows another flow diagram for a method for expectation based processing.

### DETAILED DESCRIPTION

Disclosed herein are processor-executable methods, computing systems, and related technologies for determining expectation based processing and to determine risk and pricing information based on those ratings. The system may be configured to supplement or replace correlative values (i.e. proxies) with causation variables which may be directly based on telematics in combination with loss data. The resultant pricing information may be presented to the user.

During a registration phase for auto insurance, an insurance company or an insurance agent may request biographical data. This biographical data is entered in a database and compared with actuarial data. The system collects, from the user during the registration phase biographical data, such as: Name, Age, Gender, Occupation, Vehicle, Driving History, Geographical Location, Grades (if the driver is a student), and frequency of use of the vehicle. Using software based algorithms, using actuarial data, the biographical information is analyzed to generate the initial risk profile. Table 1, below, shows an example initial risk profile for a driver. In the example shown in Table 1, the initial risk profile is compared to a computationally predetermined hypothetical driver. The hypothetical driver, for example, may be a statistically average risk driver for which no penalties or credits would be awarded to, during the registration process.

TABLE 1
Initial Risk Profile for a 16 Year Old Male with a C+ School
Average

| | Variance from | |
|---|---|---|
| Behavior | hypothetical driver | Premium Adjustment |
| Speeding | +60% | 1.1 |
| Braking | +60% | 1.1 |
| Driving Late at Night | −4% | .99 |
| Driving In Traffic | −9% | .96 |
| Lane Changes per Mile | +85% | 1.8 |
| Total Miles | 2000 | 1.4 |

As shown above, the risk profile contains specific risk behaviors that have been determined to affect the frequency and severity of potential accidents. Based on the received biographical information, the system 100 calculated risk factors for each of these behaviors. The variances from the hypothetical may be based on absolute or relative factors. For example speeding may be determined based on absolute speed, relative to posted speed limits, or speed relative to other nearby drivers. Similarly the variance for the other factors may be analyzed on an absolute or relative basis.

To replace or enhance one or more proxies for driving behavior, a vehicle 140 is equipped with a TrueLane® device that is configured to receive telematics data from one or more telematics devices regarding the actual driving behavior. In one embodiment, the vehicle 140 or the system 100 is configured to determine the identity of the driver.

The system receives the telematics data from the TrueLane® device and compares the measured value with the initial driver expectations. The system may then generate an updated risk profile, based on measured values. An updated risk profile, incorporating telematics data is shown in Table 2.

TABLE 2
Updated Risk Profile for a 16 Year Old Male with a C+ School
Average

| | | Measured | Initial Premium | Premium |
|---|---|---|---|---|
| Behavior | Expectation | Behavior | Adjustment | Adjustment |
| Speeding | +60% | +40% | 1.1 | 1.05 |
| Braking | +60% | +40% | 1.1 | 1.05 |
| Driving Late at | −4% | 0% | .99 | 1 |
| Night | | | | |
| Driving In | −9% | 2% | .96 | 1.03 |
| Traffic | | | | |
| Lane Changes | +85% | +40% | 1.8 | 1.3 |
| per Mile | | | | |
| Total Miles | 2000 | 432 | 1.4 | .9 |

As a simple, single variable example. For the example above shown in Table 2, the 16 year old driver is expected to drive 2000 miles a year. However, the measured mileage is much less (432). The system 100 may be configured to determine, based on one or more variables, whether to adjust the rate or credit or penalize the driver in the pricing. In the simple case above, if total miles driven were the only important metric, the driver may be in a position to receive a significant discount as soon as the system 100 determines that he will not be driving the expected 2000 miles. In a more complex case, a multivariate analysis may be used incorporating multiple factors, wherein the initial premium may assume this driver would be worse based on the initial driving profile. But measured results allow the insurance company to replace these proxies with actual measured data.

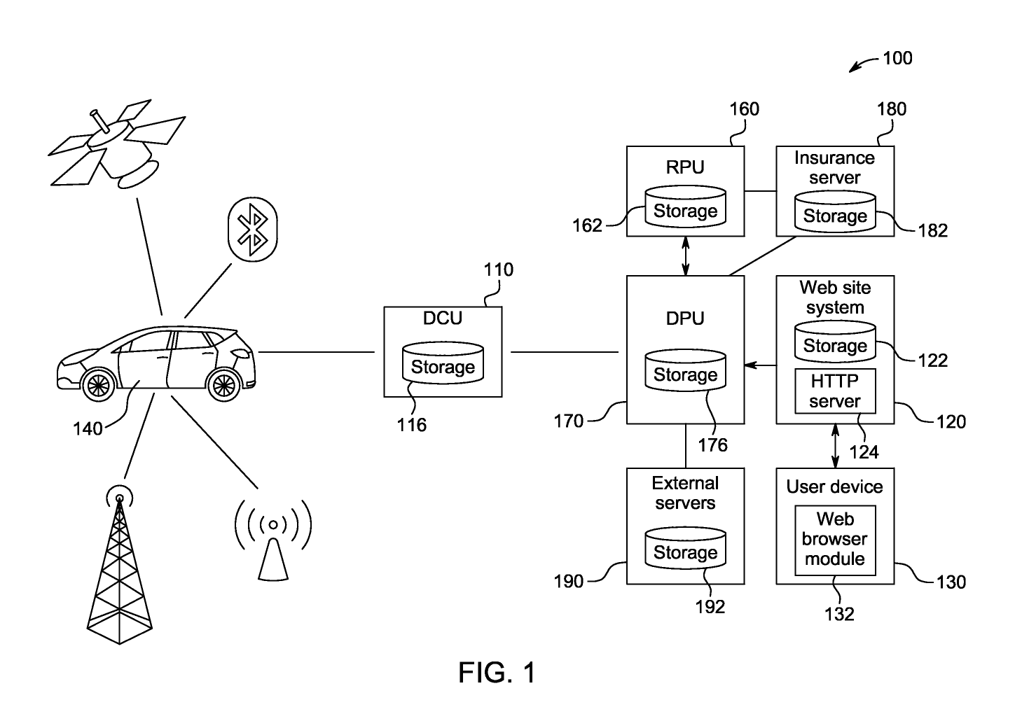

FIG. 1 shows an example system 100 that may be used for telematics based underwriting. The example system 100 includes a vehicle 140 equipped with one or more telematics devices (not pictured), for example a TrueLane® device. The telematics devices may further include smartphones, tablets and/or similar devices. The vehicle 140 may be in communication with multiple devices over different networks, including a satellite, a cellular station, a Wi-Fi hotspot, BLUETOOTH devices, and a data collection unit (DCU) 110. The DCU 110 may be operated by a third party vendor that collects telematics data. The DCU 110 may include storage 116. The DCU 110 collects the telematics data and then may transmit the telematics data to a data processing unit (DPU) 170. The telematics data may be communicated to the DPU 170 in any number of formats. In one embodiment, the DCU 110 may transmit a customized summary of the telematics data to the DPU 170, in a format useable by the DPU 170. The DPU 170 may also be configured to communicate with a risk and pricing unit (RPU) 160, including storage 162, internal insurance servers 180, including storage 182, and external servers 190 (e.g. social media networks, official/government networks), which are all connected by one or more networks

The one or more telematics devices associated with the vehicle 140 may communicate with a satellite, Wi-Fi hotspot and even other vehicles. The telematics devices associated with the vehicle 140 report this information to the DCU 110. As will be described in greater detail hereafter, the DCU 110 may transmit this telematics data to the DPU 170 which may be configured to consolidate biographic and telematics data to generate driver expectation information.

The web site system 120 provides a web site that may be accessed by a user device 130. The web site system 120 includes a Hypertext Transfer Protocol (HTTP) server module 124 and a database 122. The HTTP server module 124 may implement the HTTP protocol, and may communicate Hypertext Markup Language (HTML) pages and related data from the web site to/from the user device 130 using HTTP. The web site system 120 may be connected to one or more private or public networks (such as the Internet), via which the web site system 120 communicates with devices such as the user device 130. The web site system 120 may generate one or more web pages that provide communication setting information, may communicate the web pages to the user device 130, and may receive responsive information from the user device 130.

The HTTP server module 124 in the web site system 120 may be, for example, an APACHE HTTP server, a SUN-ONE Web Server, a MICROSOFT Internet Information Services (IIS) server, and/or may be based on any other appropriate HTTP server technology. The web site system 120 may also include one or more additional components or modules (not depicted), such as one or more load balancers, firewall devices, routers, switches, and devices that handle power backup and data redundancy.

The user device 130 may be, for example, a cellular phone, a desktop computer, a laptop computer, a tablet computer, or any other appropriate computing device. The user device 130 includes a web browser module 132, which may communicate data related to the web site to/from the HTTP server module 124 in the web site system 120. The web browser module 132 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 132 may implement Rich Internet Application (RIA) and/or multimedia technologies such as ADOBE FLASH, MICROSOFT SILVERLIGHT, and/or other technologies. The web browser module 132 may implement RIA and/or multimedia technologies using one or web browser plug-in modules (such as, for example, an ADOBE FLASH or MICROSOFT SILVERLIGHT plug-in), and/or using one or more sub-modules within the web browser module 132 itself. The web browser module 132 may display data on one or more display devices (not depicted) that are included in or connected to the user device 130, such as a liquid crystal display (LCD) display or monitor. The user device 130 may receive input from the user of the user device 130 from input devices (not depicted) that are included in or connected to the user device 130, such as a keyboard, a mouse, or a touch screen, and provide data that indicates the input to the web browser module 132.

The example system architecture 100 of FIG. 1 may also include one or more wired and/or wireless networks (not depicted), via which communications between the elements in the example architecture 100 may take place. The networks may be private or public networks, and/or may include the Internet.

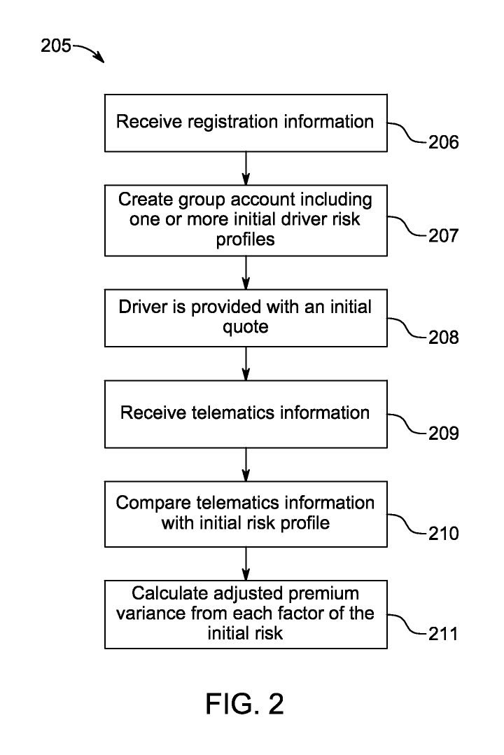

Each or any combination of the modules shown in FIG. 1 may be implemented as one or more software modules, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 1, these modules may perform functionality described herein with reference to FIGS. 2-16.

FIG. 2 shows an example use case for method 205 for expectation based processing. The system 100 receives registration information regarding the user (step 206). This information may include biographical information (such as the numbers of family members, age, marital status, education, address information, number and type of vehicles). Based on this information, the system 100 creates a group account (step 207). The group account may include subaccounts for each individual driver (in the case of multiple insured). The system 100 uses a software based algorithm to generate initial driver risk profiles, based on stored loss statistics. The system 100 may then generate pricing information based on this initial risk profile (step 208). If the user accepts the pricing, the account is activated and the system 100 begins receiving and stores driver telematics data associated with the account (step 209). At predetermined or requested intervals, the system compares the received telematics data and compares each measured value with the expected value in the initial driver risk profile (step 210). Using software based algorithms, the system 100 may credit or penalize each driver based on variances from the initial driver expectation profile and determine pricing information, including adjusting a rate, providing a credit or penalty, deny coverage, or recommend a different insurance product (step 211). As opposed to previous systems which merely adjusted rates on a whole premium basis. The system 100 is configured to adjust the pricing based on multiple factors determined by the telematics data. The system 100 may be able to adjust the pricing in multiple ways, for example by adjusting the rate, or providing a credit, or a penalty, based on the telematics data. Alternatively, the system 100 may be configured to generate an initial risk profile on a group basis. For example, for a family of four with two cars and four drivers, an aggregate initial risk profile may be generated. Based on this aggregate initial risk profile, the group is assessed a premium based on driver averaging. Accordingly, if the aggregate telematics data varies from the aggregate initial driver risk profile, the pricing may be adjusted by adjusting the rate, crediting or penalizing the account, denying continuing coverage, or recommending a different insurance product for the user. The updated pricing information may be presented to the user of a user device 130. The techniques described herein may be used to compare various methods of determining the pricing of vehicle insurance. For example, some companies may use a blended rate to determine premiums; others may determine this based on attributing the worst driver on a policy to the highest risk vehicle. Using the methods described herein, the insurance company can adjust the pricing information from either scheme.

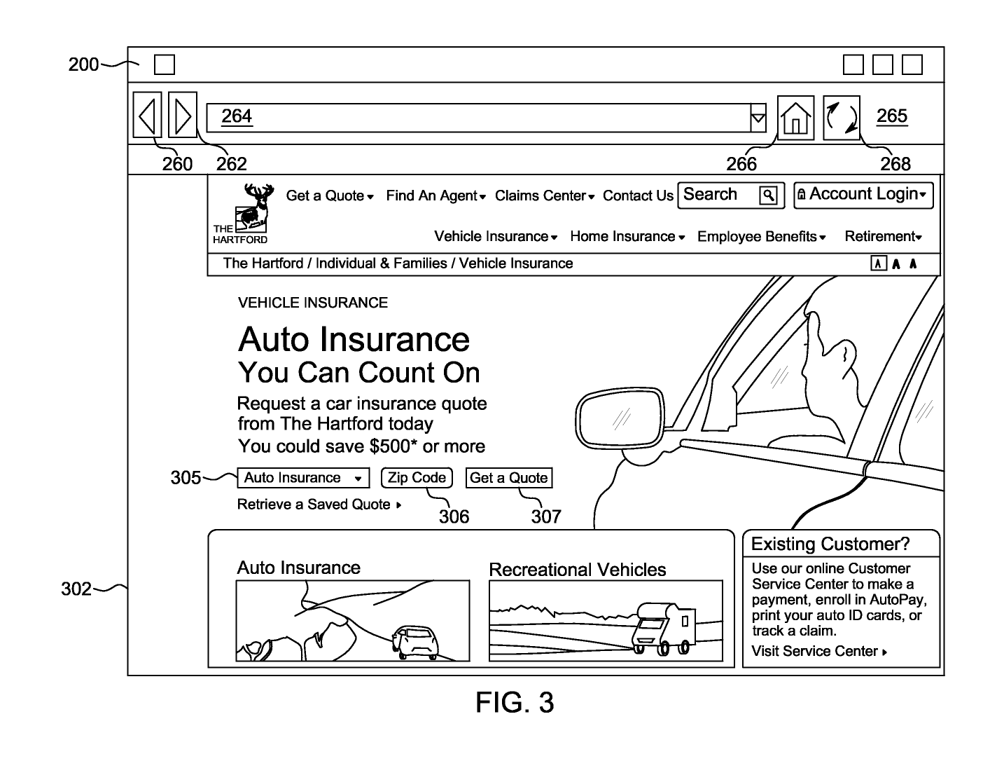

FIGS. 3-13 show example web pages that may be displayed by the web browser module 132. As will be described in detail below, the web pages may include display elements which allow the user of the user device 130 to interface with the system 100 and register or receive a quote for vehicle insurance. The web pages may be included in a web browser window 200 that is displayed and managed by the web browser module 132. The web pages may include data received by the web browser module 132 from the web site system 120. The web pages may include vehicle insurance information.

The web browser window 200 may include a control area 265 that includes a back button 260, forward button 262, address field 264, home button 266, and refresh button 268. The control area 265 may also include one or more additional control elements (not depicted). The user of the user device 130 may select the control elements 260, 262, 264, 266, 268 in the control area 265. The selection may be performed, for example, by the user clicking a mouse or providing input via keyboard, touch screen, and/or other type of input device. When one of the control elements 260, 262, 264, 266, 268 is selected, the web browser module 132 may perform an action that corresponds to the selected element. For example, when the refresh button 268 is selected, the web browser module 132 may refresh the page currently viewed in the web browser window 200.

FIG. 3 is an example web page 302 for initiating a request for a vehicle insurance quote. As shown in FIG. 3, the web page 302 may include questions accompanied by multiple input fields 305-307 in the form of drop down lists, text fields, and radio buttons. As the user provides input into the input fields 305-307, the web browser module 132 may store one or more data structures (“response data”) that reflect the selections made in the input fields 305-307. Further, as the selections are updated, the web browser module 132 may update the web page 302 to indicate additional or more specific questions that may be associated with the selections. If there are no errors in the transmission, the web browser module 132 is directed to a subsequent web page. While the example shown is for auto insurance, the methods and apparatus disclosed herein may be applied to any vehicle insurance, e.g. boats, planes, motorcycles etc. Also, while the examples are directed to family auto insurance, the methods and apparatus disclosed herein may be applicable to corporate insurance plans, or any policies covering vehicles.

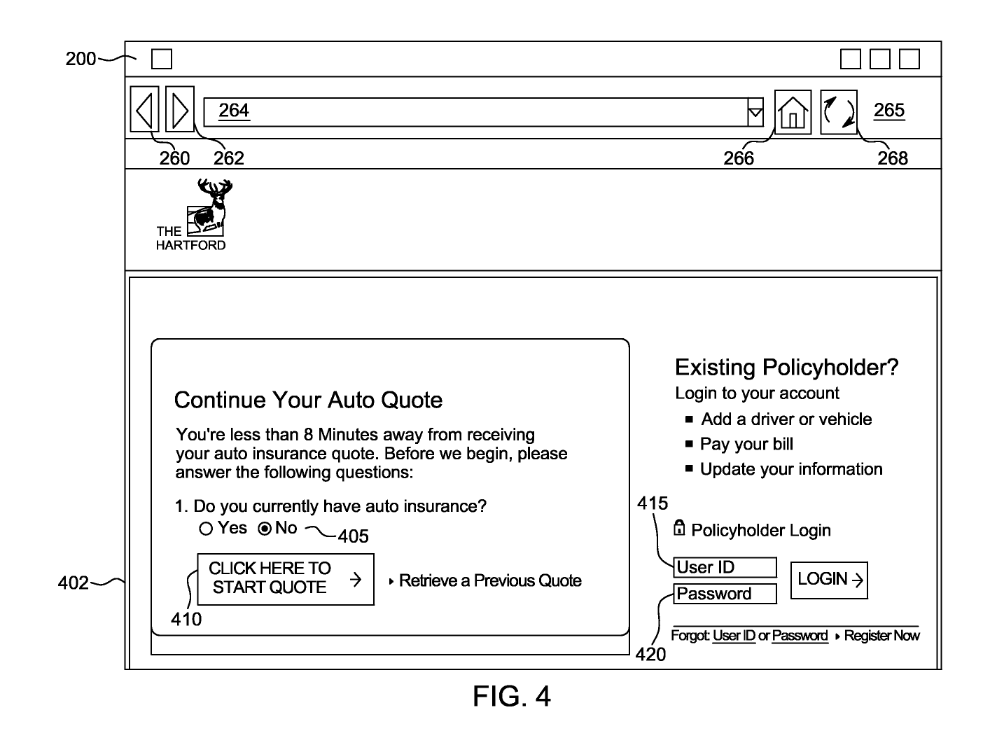

FIG. 4 is an example web page 402 soliciting preliminary information regarding a request for a vehicle insurance quote. As shown in FIG. 4, the web page 402 may include multiple input fields 405, 410, 415, and 420. As the user device 130 receives input for the input fields, the web browser module 132 may store one or more data structures (“response data”) that reflect the selections made in the input fields. Further, as the selections are updated, the web browser module 132 may update the web page 402 to indicate additional or more specific questions that may be associated with the selections. At any time, while viewing the web page 402 of FIG. 4, the user may enter user identification information in input fields 415 and 420, which accesses previously stored information associated with the user. If there are no errors in the transmission, the web browser module 132 is directed to a subsequent web page.

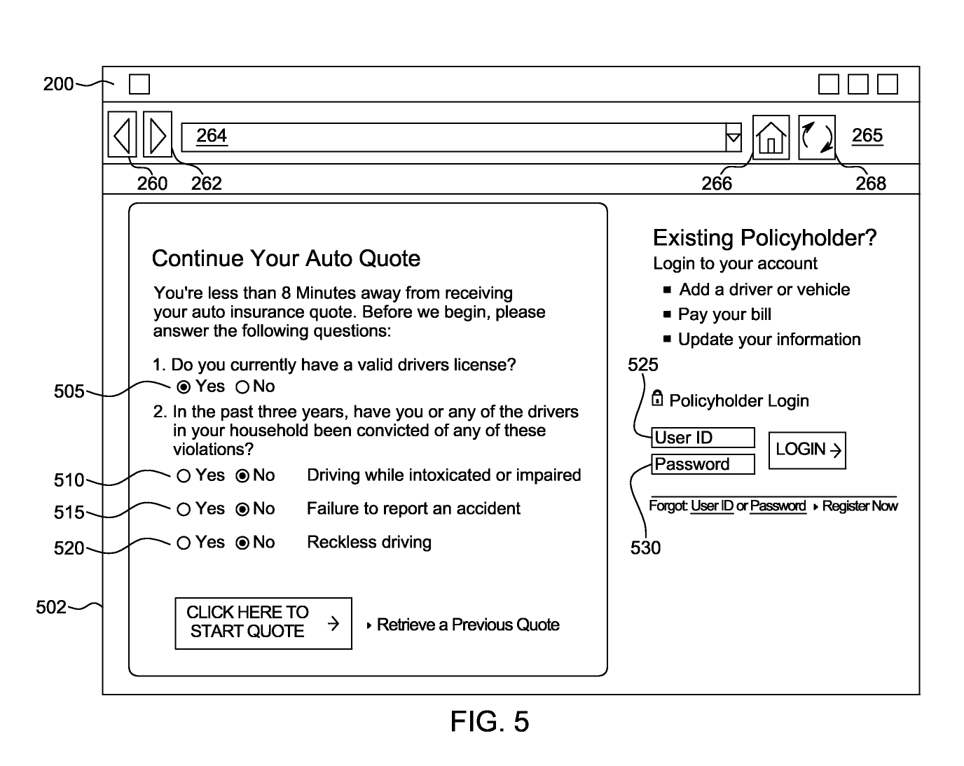

FIG. 5 is an example web page 502 soliciting additional preliminary information regarding a request for a vehicle insurance quote. As shown in FIG. 5, the web page 502 may include multiple input fields 505, 510, 515, 520, 525, and 530. As the user device 130 receives input for the input fields, the web browser module 132 may store one or more data structures (“response data”) that reflect the selections made in the input fields. Further, as the selections are updated, the web browser module 132 may update the web page 502 to indicate additional or more specific questions that may be associated with the selections. At any time, while viewing the web page 502 of FIG. 5, the user may enter user identification information in input fields 525 and 530, which accesses previously stored information associated with the user. Web page 502 solicits additional questions, for example, whether the user currently has a valid driver's license and whether the user or associated family has had any major driving violations. Such violations alert the system 100 that the user may be directed to a different insurance product. Additionally, while the telematics program is voluntary for some users, in one embodiment, a potential user may be eligible for additional products if they consent to using the telematics program, whereas previously they may have been disqualified. If there are no errors in the transmission, the web browser module 132 is directed to a subsequent web page.

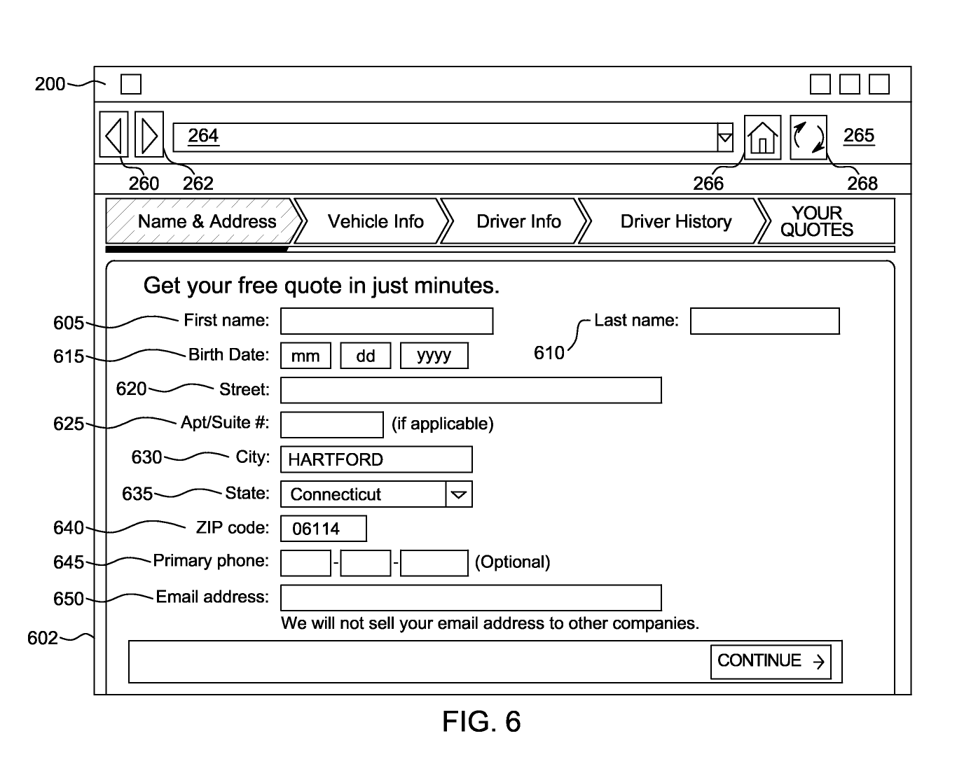

FIG. 6 is an example web page 602 soliciting name and address information of the individual requesting an insurance quote. As shown in FIG. 6, the web page 602 may include multiple input fields 605, 610, 615, 620, 625, 630, 635, 640, 645 and 650. As the user device 130 receives input for the input fields, the web browser module 132 may store one or more data structures (“response data”) that reflect the selections made in the input fields. Further, as the selections are updated, the web browser module 132 may update the web page 602 to indicate additional or more specific questions that may be associated with the selections. The questions displayed on web page 602 solicit questions regarding the contact information of the individual applying for insurance. As an example, the questions shown in FIG. 6 include: name, date of birth, address, phone number, and email address. If there are no errors in the transmission, the web browser module 132 is directed to a subsequent web page.

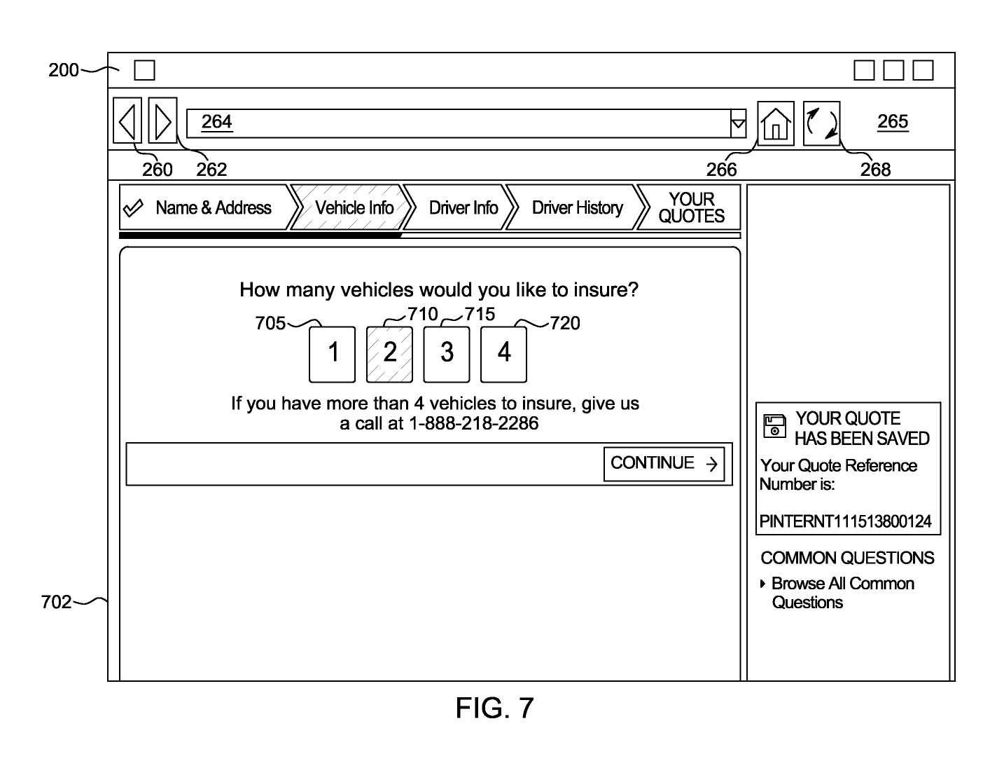

FIG. 7 is an example web page 702 soliciting vehicle information regarding a request for a vehicle insurance quote. As shown in FIG. 7, the web page 702 may include radio buttons 705, 710, 715, and 720. As the user device 130 receives input selecting a radio button, the web browser module 132 may store one or more data structures (“response data”) that reflect the selections made. Further, as the selections are updated, the web browser module 132 may update the web page 702 to indicate additional or more specific questions that may be associated with the selections. The question displayed on web page 702 solicits information regarding the number of vehicles for which insurance is being requested. While the example shown in FIG. 7 only allows four vehicles, this is as an example only. More or less vehicles may be allowed. If there are no errors in the transmission, the web browser module 132 is directed to a subsequent web page.

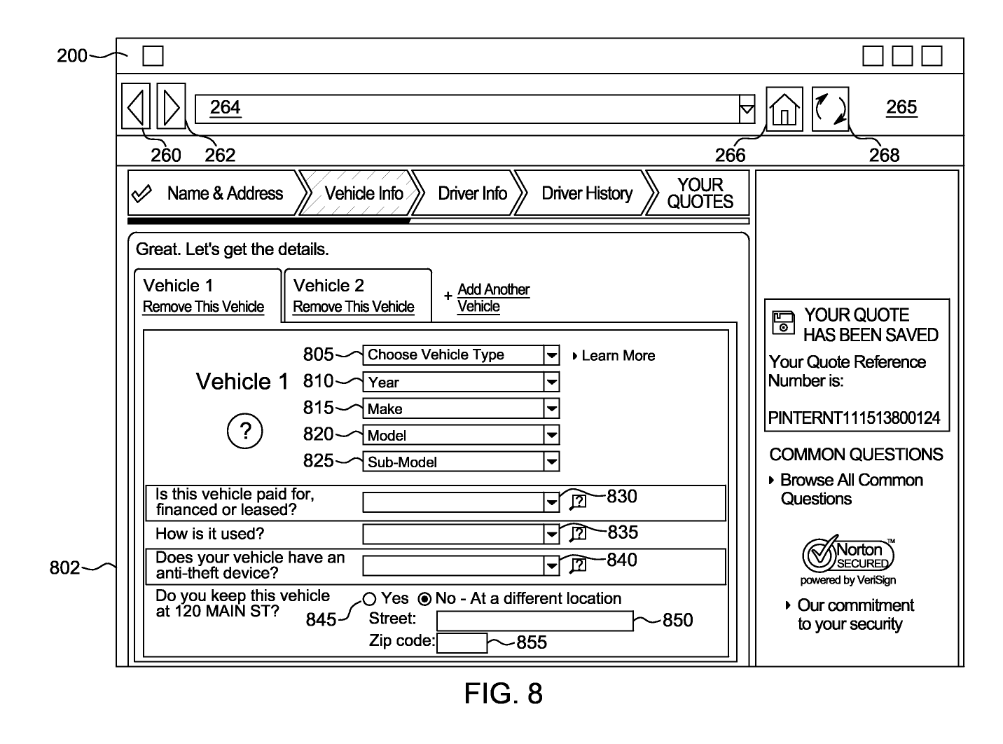

FIG. 8 is an example web page 802 soliciting additional vehicle information regarding a request for a vehicle insurance quote. As shown in FIG. 8, the web page 802 may include radio buttons 805-855, for example, radio buttons Choose Vehicle Type 805, Year 810, Make 815, Model 820, Sub-Model 825, is this vehicle paid for, financed or leased? 830, How Is It used 835, Does your vehicle have an anti-theft device? 840, Yes or No—At a different location 845, Street 850 and Zip code 855. As the user device 130 receives inputs, the web browser module 132 may store one or more data structures (“response data”) that reflect the selections made. Further, as the selections are updated, the web browser module 132 may update the web page 802 to indicate additional or more specific questions that may be associated with the input. The question displayed on web page 802 solicits information regarding where the user is requested to enter vehicle type, year, make, model, and other information. The user is also requested to enter information as to how the vehicle is paid for, how the vehicle is used, whether there is anti-theft equipment, and where the vehicle is stored. The web page 802 also includes tabs to add data for additional vehicles and to remove vehicles. If there are no errors in the transmission, the web browser module 132 is directed to a subsequent web page.

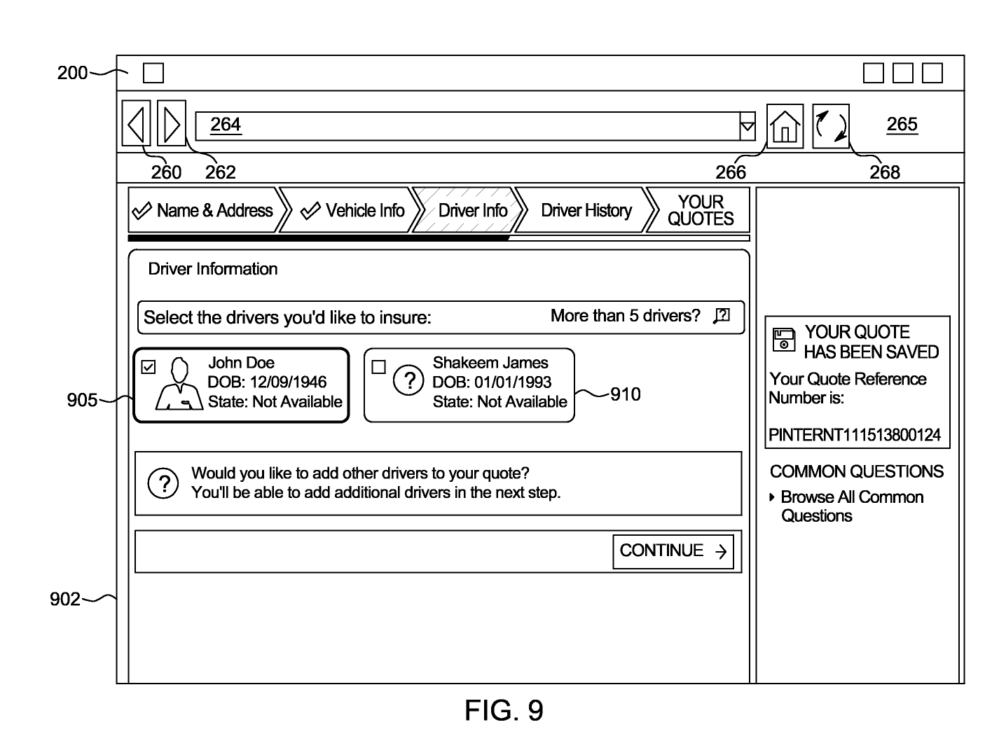

FIG. 9 is an example web page 902 soliciting driver information regarding a request for a vehicle insurance quote. As shown in FIG. 9, the web page 902 may include radio buttons 905 and 910. As the user device 130 receives inputs, the web browser module 132 may store one or more data structures (“response data”) that reflect the selections made. Further, as the selections are updated, the web browser module 132 may update the web page 902 to indicate additional or more specific questions that may be associated with the input. The question displayed on web page 902 solicits information regarding the identity of vehicle(s) for which insurance is being requested. Radio button 905 for example, contains information that is generated based on the user information entered via web page 902. Additionally, the system 100 may be configured to access data associated with the address information and determined suggested drivers, as shown in radio button 910. If there are no errors in the transmission, the web browser module 132 is directed to a subsequent web page.

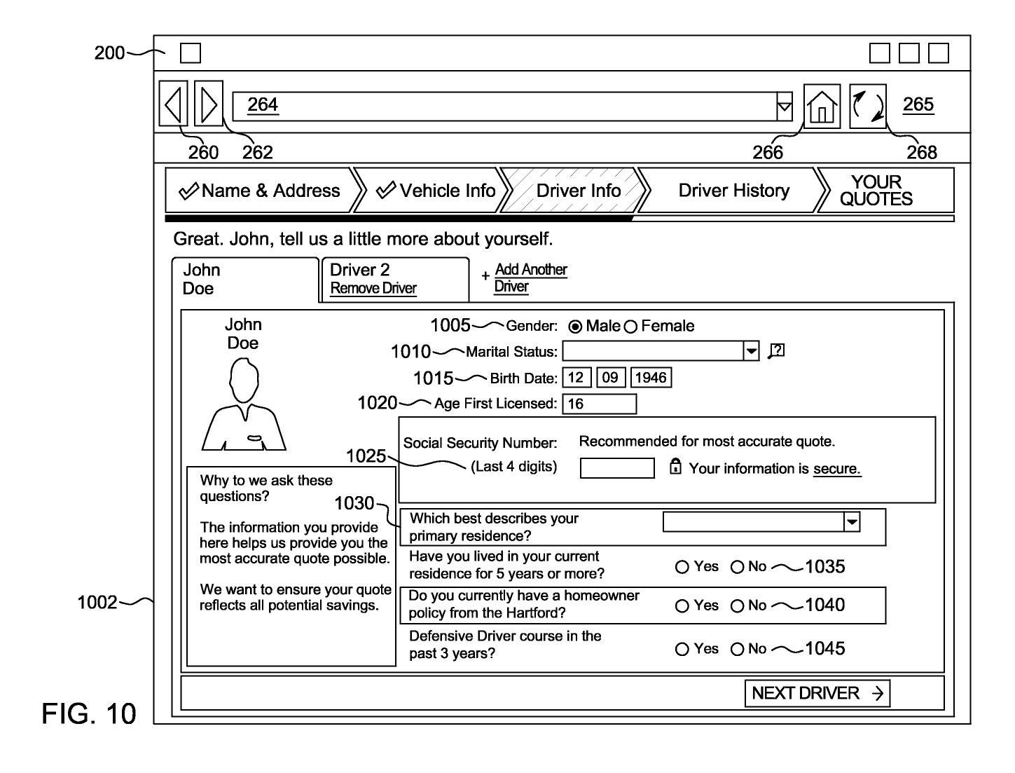

FIG. 10 is an example web page 1002 soliciting additional driver information regarding a request for a vehicle insurance quote. As shown in FIG. 10, the web page 1002 may include input fields 1005-1045, for example, input fields Gender 1005, Marital Status 1010, Birth Date 1015, Age First Licensed 1020, Social Security Number 1025, Which best describes your primary residence 1030, Have you lived in your current residence for 5 years or more 1035, Do you currently have a homeowner policy from the Hartford? 1040, Defensive Driver course in the past 3 years? 1045. As the user device 130 receives inputs, the web browser module 132 may store one or more data structures (“response data”) that reflect the selections made. Further, as the selections are updated, the web browser module 132 may update the web page 1002 to indicate additional or more specific questions that may be associated with the input. The question displayed on web page 1002 solicits information regarding the identity of vehicle(s) for which insurance is being requested. The system 100 may have access to additional database information to confirm or autofill information in the web page 1002. For example, based on the user's social security number, the system 100 may determine background information or confirm the identity. Web page 1002 allows the user to enter all of the additional drivers to be insured, along with their corresponding information. Additional information may also be requested, for example, height, weight, cell phone number, employment information. The system 100 may further be configured to access information, for example from the local department of motor vehicles. This may enable the insurance company to access height and weight information, which may be used for driver expectation based processing as described in greater detail below. If there are no errors in the transmission, the web browser module 132 is directed to a subsequent web page.

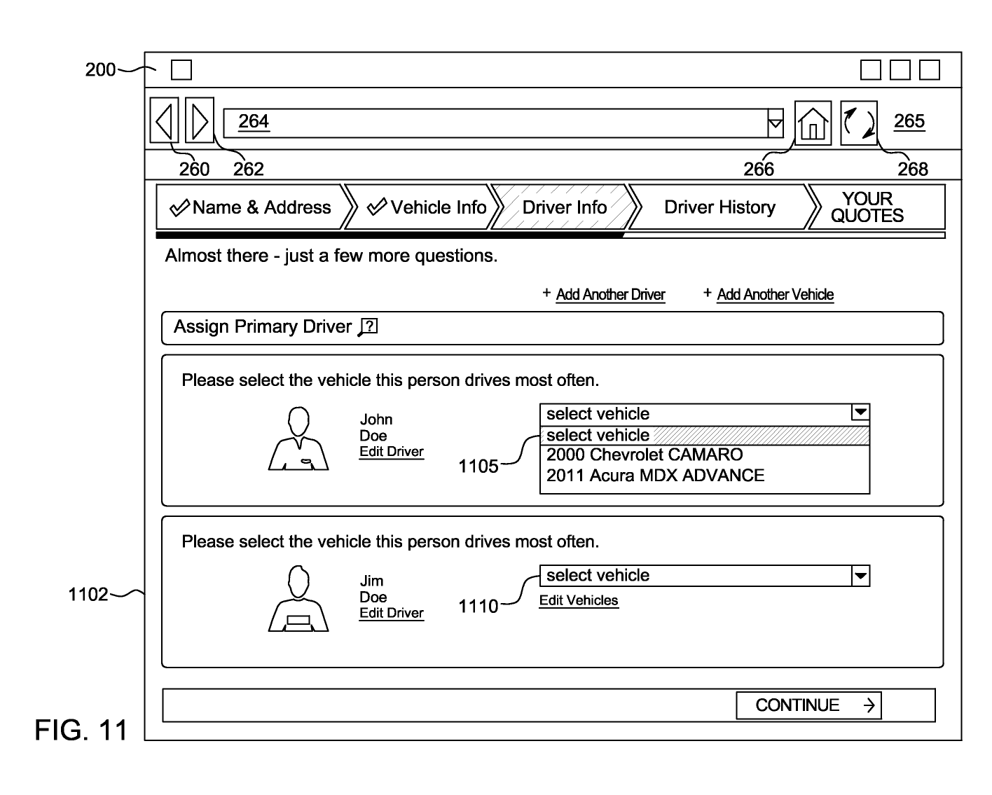

FIG. 11 is another example web page 1102 soliciting additional information regarding a request for a vehicle insurance quote. As shown in FIG. 11, the web page 1102 may include dropdown menus 1105 and 1110. As the user device 130 receives inputs, the web browser module 132 may store one or more data structures (“response data”) that reflect the selections made. Further, as the selections are updated, the web browser module 132 may update the web page 1102 to indicate additional or more specific questions that may be associated with the input. The question displayed on web page 1102 solicits information regarding the primary vehicles being driven by each driver. If there are no errors in the transmission, the web browser module 132 is directed to a subsequent web page.

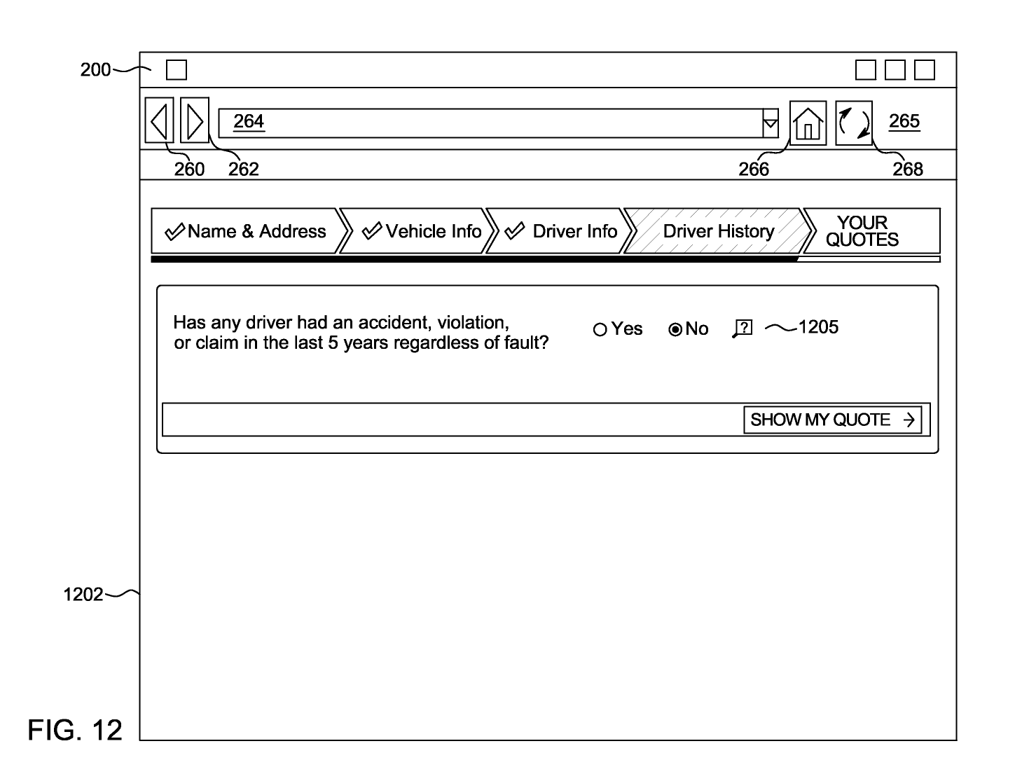

FIG. 12 is an example web page 1202 soliciting driver history information regarding a request for a vehicle insurance quote. As shown in FIG. 12, the web page 1202 may include radio button 1205. As the user device 130 receives inputs, the web browser module 132 may store one or more data structures (“response data”) that reflect the selections made. Further, as the selections are updated, the web browser module 132 may update the web page 1202 to indicate additional or more specific questions that may be associated with the input. The question displayed on web page 1202 solicits information regarding the driver history for each of the drivers. If there are no errors in the transmission, the web browser module 132 is directed to a subsequent web page.

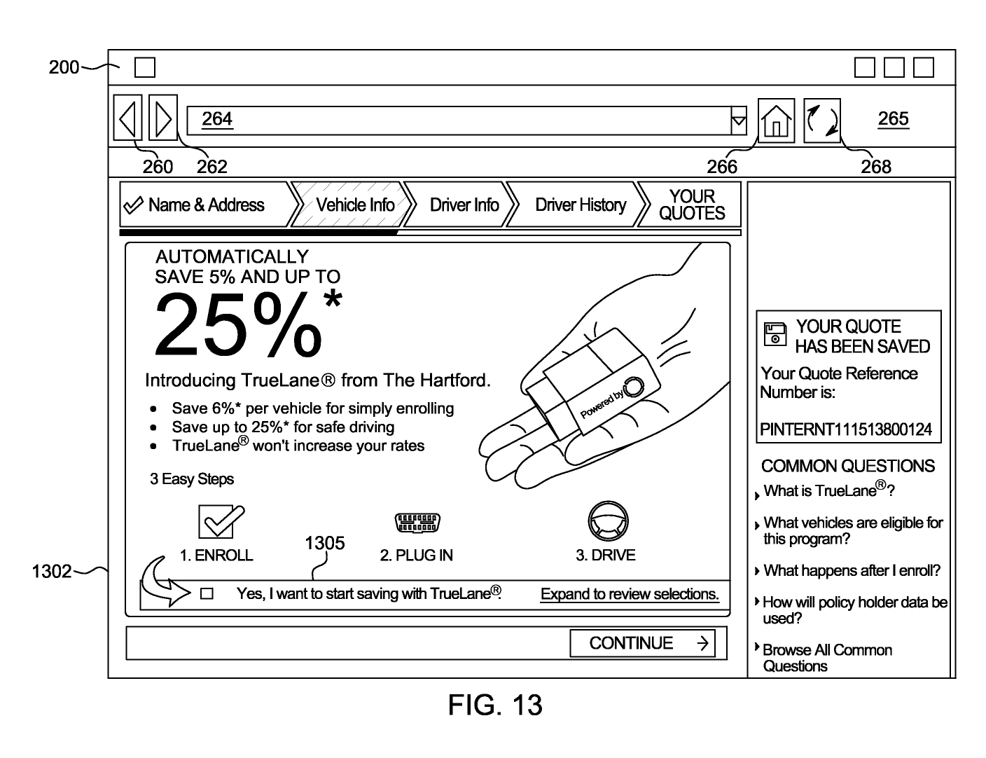

FIG. 13 is an example web page 1302 soliciting a response from the user for registration to TrueLane® telematics program. As shown in FIG. 13, the web page 1302 may include a radio button 1305. As the user device 130 receives inputs, the web browser module 132 may store one or more data structures (“response data”) that reflect the selections made. Further, as the selections are updated, the web browser module 132 may update the web page 1302 to indicate additional or more specific questions that may be associated with the input. Based on the previous answers supplied by the user, the system 100 determines whether the user is eligible for the TrueLane® discount. Alternatively, if the driver or vehicle is in a higher risk category, TrueLane® may be required in order to receive or maintain insurance coverage. The question displayed on web page 1302 confirms enrollment in the TrueLane® telematics program. If there are no errors in the transmission, the web browser module 132 is a quote.

While the below examples describe a scenario of a new customer registering for insurance and then having the pricing adjusted based on telematics data, the systems and methods described herein may be applied to current and former customers who are looking to renew their coverage. In this scenario, the biographical information may already be stored on the insurance server 180, and the DPU 170 may access this information directly.

In addition to the example information above, additional information may be determined during or after the registration phase. For example, Table 3 shows biographical information that may be used in generating driver risk profiles.

TABLE 3
Additional Driver Information

Primary Metric
Household Composition
Presence of Married or Domestic
Partners/Total Number of Drivers
Youthful Policy Composition
Driver Age/Gender-Marital Status
Driver Age/Annual Mileage
Limited Driving
Driver Age/Driver Training
Driver Age/Good Student
Driver Age/Principal/Occasional
Operator
Driver Age/Years Licensed
Vehicle Age*/Driver Age
Driver Age/Prior BI Limit
Driver Age/Number of Drivers
Driver Age/Number of Vehicles
Driver Age - Household Composition
Primary Insured Age
Primary Insured Gender
Secondary Insured Age
Primary and Secondary Driver Age
Difference
Secondary Metric
Vehicle Age*/Number of Vehicles
Annual Mileage
Vehicle Use
Number of Renewal Years
Safe Driver Insurance Plan
Chargeable at-fault accidents - First
Year/Subsequent Years
Safe Driver Insurance Plan
Minor violations excluding speeding -
First Year/Subsequent Years
Safe Driver Insurance Plan
Major violations excluding DWI - First
Year/Subsequent Years
Safe Driver Insurance Plan
Minor violations - speeding only - First
Year/Subsequent Years
Safe Driver Insurance Plan
Major violations - DWI only - First
Year/Subsequent Years
Usage Based Insurance Score

The system 100 may be configured to weight each factor based on actuarial date. For example, in the example above, there are two categories, primary and secondary wherein each factor within a particular category may be weighted equally. However, each factor may be assigned a unique weight.

The registration phase is used to generate an initial risk profile, as shown in Table 1, above. During the registration phase, the system 100 received biographical information about each of the drivers that may be associated with the user's account as well information about the vehicles for which coverage is requested. With millions of accidents each year, a large amount of data is available on factors that may affect the likelihood of an accident as well as the severity of the accident. The database 176 associated with the DPU 170 contains information regarding accident information. The DPU 170, using a multivariate analysis, generates the initial driver profile based on the provided biographic information verses the factors stored in the database 176.

The inside of the vehicle 140 may include a plurality of electronic devices that may communicate information to the telematics device. Many vehicles include at least one microprocessor and memory that connects to each individual electronic device. For example, there may be electronic devices associated with the seats, A/C units, global positioning satellite (GPS)/stereo system, DVD unit, and BLUETOOTH equipment. The microprocessor may also be in communication with the headlights, engine, traffic signals, rear view mirror, rearview cameras, cruise control, braking system and inner workings of a vehicle 140. There may also be additional devices such as multiple mobile phones brought by passengers into the vehicle 140. The telematics device is configured to receive information from the electronics in the vehicle 140. For example, the telematics device is configured to receive data concerning, speed, acceleration, braking, location, seat settings, lane changes, radio volume, window controls, vehicle servicing, number of cellular devices in the vehicle 140, proximity to other vehicle's, etc. The telematics device may be configured to transmit this information directly to the DCU 110. The DCU 110 may be configured to format the received information and transmit it to the DPU 170.

The DPU 170 may be configured to use this information to determine the driving behavior associated with an individual driver, or the vehicle. In one embodiment, the DPU 170 may be configured to identify the driver using a driver signature, for example, as disclosed in co-pending U.S. application Ser. No. 14/145,142, titled SYSTEM AND METHOD FOR DETERMINING DRIVER SIGNATURES filed Dec. 31, 2013.

The telematics device may be configured to include an event/status monitor of the vehicle's 140 activities. An example of the event/status log, which may be stored in a database operatively coupled to the telematics device, is shown in Table 4.

TABLE 4
Measured Driving Behavior

| | | Radio | Phone | Loca- | | Turn- | Turn |
|---|---|---|---|---|---|---|---|
| Time | Speed | Volume | in Use | tion | Brakes | ing | Signal |
| 1:05am | 76 | 8 | | 32605 | | | |
| 1:06am | 86 | 8 | Y | 32605 | Y | | |
| 1:07am | 54 | 8 | | 32606 | | | |
| 1:08am | 86 | 9 | N | 32606 | Y | Y | N |
| 1:09am | 52 | 9 | | 32606 | | | |

The telematics device may be configured to take periodic measurements regarding the vehicle, as well as event triggered measurements. For example, the telematics device may be configured to take readings every 5 minutes. However, events such as a detected turn, brake, and phone activation may trigger additional readings. The example above is not exhaustive; the metrics are shown as example only.

The telematics device may transmit the recorded information to the DCU 110. The DCU 110 formats this information and transmits it to the DPU 170, which may then compare this data with the expected driving behaviors.

The RPU 160 may access the database 176 associated with the DPU 170 to determine adjusted pricing information based on the variance from the expected driving behavior.

The system 100 uses the biographical information provided in web pages 302-1302 as a baseline for generating the initial premium. However, the telematics data, provided by the telematics device may be used to refine this information. The RPU 160 may access the information stored in the DPU 170, and use a software based algorithm to determine a discount or penalty.

In a first example, the system 100 may offer the user a predetermined discount to sign up for the telematics device. The system 100 may be configured to generate a discount factor, for example according to the following equation:

Discount relativity=starting discount*β₁ρ₁*β₂ρ₂*β₃ρ₃* . . . βₙρₙ,
where β=weighting factor and ρ=risk factor score.

For example, the starting discount may be 10%, and if the product of the risk and weighting factors >1, the system 100 may determine the driver is not eligible for a discount.

In one scenario, the system 100 may only receive telematics data for a fixed time period. In this scenario, the RPU 160 may be configured to compensate for the limited duration of the telematics data using a seasonality factor. For example, if the telematics data is received from September-December, and the biographical information indicates one of the insured drivers attends college away from home, RPU 160 may be configured to use the seasonality factor to adjust the pricing information to account for the lack of information transmitted regarding that driver. Conversely, under the same scenario, if the readings were taken during the summer, when the student was home, the telematics data may be skewed the other way. Accordingly, the RPU 160 may use the seasonality factor to account for that.

Additionally, the system 100 may identify unknown or undisclosed drivers based on the received telematics data.

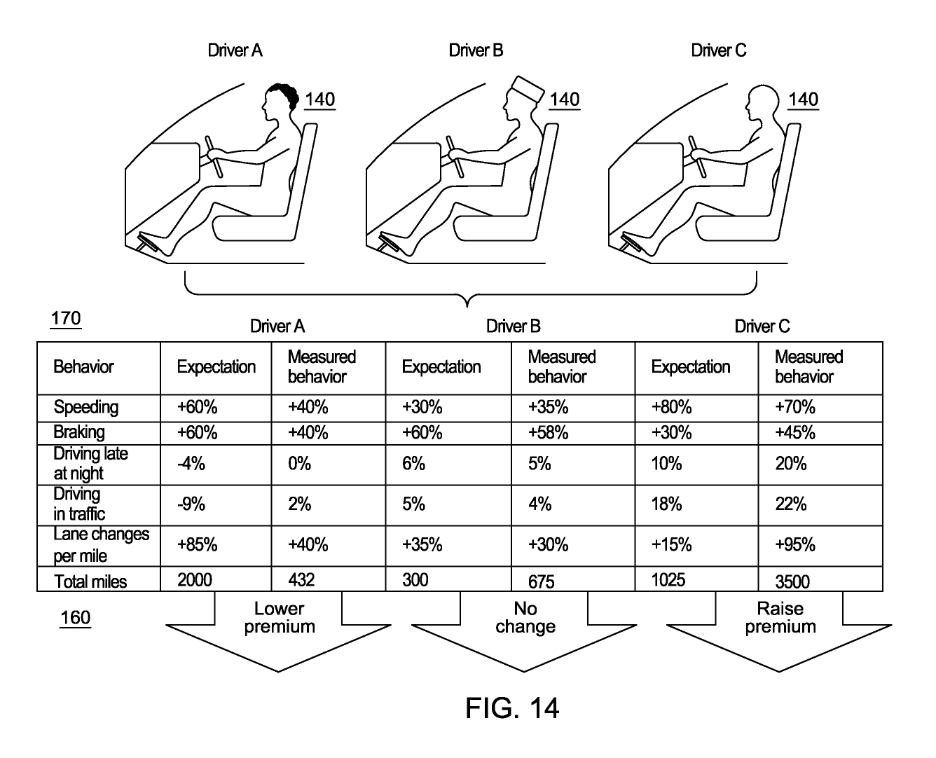

FIG. 14 shows three examples of expectation based processing. As shown in FIG. 14, the three drivers may all be drivers of the same vehicle 140. The drivers include different genders, ages, credit rating, etc. Based on the initial biographic information, the DPU 170 determined an expectation of driver behavior. In the example shown, the DPU 170 determined expected values for speeding, braking, driving late at night, driving in traffic, lane changes and total mileage. The speeding, braking, driving late at night, driving in traffic and lane changes per mile are all represented in relative terms. Wherein the driver is evaluated against a hypothetical baseline driver. The expected values are determined based on the differences of a driver in a risk class versus that baseline driver. The DPU 170 receives telematics information, either directly from a telematics device, or indirectly through a third party operated system. In the example shown in FIG. 14, the received telematics data is summary data for the factors shown in the table. The DPU 170 compares the measured behavior to the expectation. As shown in FIG. 14, Driver A is expected to brake, speed and change lanes far more often than the hypothetical baseline driver. The actual values show that while Driver A is in fact worse than the hypothetical baseline driver, the difference is not nearly as much as expected. The RPU 160 receives the comparison information related to Driver A, and determines that Driver A is in line for a lower premium. The RPU 170 may be configured to determine a new rate for the driver or it may keep the same rate, but provide the driver with a credit. Driver B is expected to be a better driver than Driver A. Driver B's measured behavior is similar to Driver A, but Driver B does not get a discount. This is because Driver B was expected to be better than Driver A. As shown in FIG. 14, the measured behavior of Driver B is very close to the expectation. The RPU 160 may be configured with a threshold wherein if the measured driving behavior is within a predetermined value of the expectation, it may not change the premium. In the example shown in FIG. 14, the variance of Driver B from the expectation for Driver B, that the pricing information is not changed. The measured behavior associated with Driver C is worse than the expectation; accordingly, the RPU 160 determines a new premium that is higher, which reflects the higher risk associated with that driver's driving behavior.

In another example of expectation based rating, a driver proxy score (DPS) may be derived from a combination of rating variables in a conventional class plan. Table 5, below, shows an example of a driver proxy score.

TABLE 5
Driver Proxy Score

| | Age | Sex | Marital | Credit | Driver Proxy Score (DPS) |
|---|---|---|---|---|---|
| Driver 1 | 16 | M | U | Good | 25 |
| Driver 2 | 45 | F | M | Excellent | 10 |

The DPU 170 may receive the telematics data and generate a driver telematics score (DTS). Table 6, below shows an example of a driver telematics score.

TABLE 6
Driver Telematics Score

| | | | | Driver Telematics Score |
|---|---|---|---|---|
| | Speeding | Braking | Miles Driven | (DTS) |
| Driver 1 | Average | Average | Low | 12 |
| Driver 2 | Average | Average | Low | 12 |

The DPU 170 may standardize the risk scores in Tables 5 and 6 using multivariate statistical techniques, to make them comparable on the same risk scale. An expectation based rating (EBR_{—} may be calculated as follows:

Expectation Based Rating (EBR) for Driver 1=actual/expected=12/25=0.48

Expectation Based Rating (EBR) for Driver 2=actual/expected=12/10=1.2

As shown, by the scores above, two drivers with the same DTS may receive different EBRs based on their expected behavior from a conventional class plan. Driver 1 may receive a discount as the actual driving behavior is better than expected whereas Driver 2 may receive a surcharge as the actual driving behavior is worse than expectation.

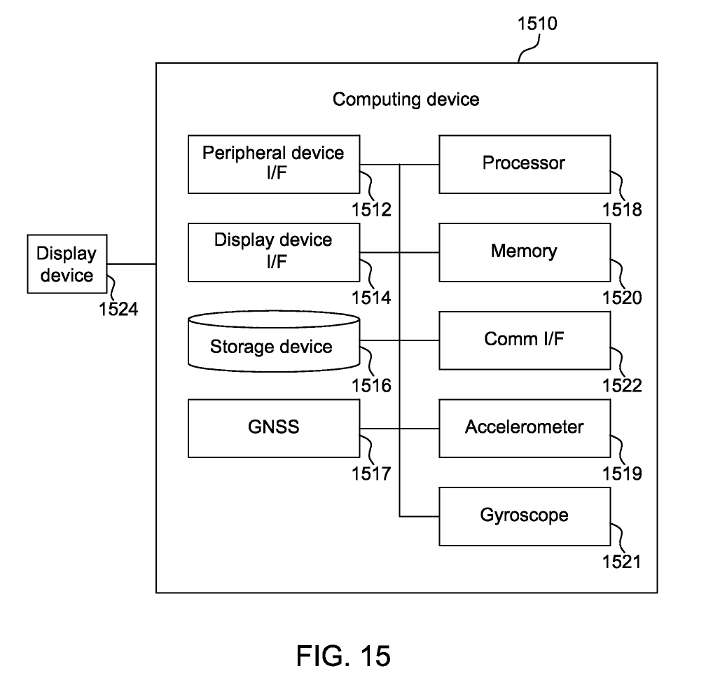

FIG. 15 shows an example computing device 1510 that may be used to implement features described above with reference to FIGS. 1-14. The computing device 1510 includes a global navigation satellite system (GNSS) receiver 1517, an accelerometer 1519, a gyroscope 1521, a processor 1518, memory device 1520, communication interface 1522, peripheral device interface 1512, display device interface 1514, and a storage device 1516. FIG. 15 also shows a display device 1524, which may be coupled to or included within the computing device 1510.

The memory device 1520 may be or include a device such as a Dynamic Random Access Memory (D-RAM), Static RAM (S-RAM), or other RAM or a flash memory. The storage device 1516 may be or include a hard disk, a magneto-optical medium, an optical medium such as a CD-ROM, a digital versatile disk (DVD), or BLU-RAY disc (BD), or other type of device for electronic data storage.

The communication interface 1522 may be, for example, a communications port, a wired transceiver, a wireless transceiver, and/or a network card. The communication interface 1522 may be capable of communicating using technologies such as Ethernet, fiber optics, microwave, xDSL (Digital Subscriber Line), Wireless Local Area Network (WLAN) technology, wireless cellular technology, BLUETOOTH technology and/or any other appropriate technology.

The peripheral device interface 1512 may be an interface configured to communicate with one or more peripheral devices. As an example, the peripheral device may communicate with an onboard diagnostics (OBD) unit that is associated with a vehicle. The peripheral device interface 1512 may operate using a technology such as Universal Serial Bus (USB), PS/2, BLUETOOTH, infrared, serial port, parallel port, and/or other appropriate technology. The peripheral device interface 1512 may, for example, receive input data from an input device such as a keyboard, a mouse, a trackball, a touch screen, a touch pad, a stylus pad, and/or other device. Alternatively or additionally, the peripheral device interface 1512 may communicate output data to a printer that is attached to the computing device 1510 via the peripheral device interface 1512.

The display device interface 1514 may be an interface configured to communicate data to display device 1524. The display device 1524 may be, for example, an in-dash display, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 1514 may operate using technology such as Video Graphics Array (VGA), Super VGA (S-VGA), Digital Visual Interface (DVI), High-Definition Multimedia Interface (HDMI), or other appropriate technology. The display device interface 1514 may communicate display data from the processor 1518 to the display device 1524 for display by the display device 1524. As shown in FIG. 15, the display device 1524 may be external to the computing device 1510, and coupled to the computing device 1510 via the display device interface 1514. Alternatively, the display device 1524 may be included in the computing device 1510.

An instance of the computing device 1510 of FIG. 15 may be configured to perform any feature or any combination of features described above as performed by the user device 130. In such an instance, the memory device 1520 and/or the storage device 1516 may store instructions which, when executed by the processor 1518, cause the processor 1518 to perform any feature or any combination of features described above as performed by the web browser module 132. Alternatively or additionally, in such an instance, each or any of the features described above as performed by the web browser module 132 may be performed by the processor 1518 in conjunction with the memory device 1520, communication interface 1522, peripheral device interface 1512, display device interface 1514, and/or storage device 1516.

Although FIG. 15 shows that the computing device 1510 includes a single processor 1518, single memory device 1520, single communication interface 1522, single peripheral device interface 1512, single display device interface 1514, and single storage device 1516, the computing device may include multiples of each or any combination of these components, and may be configured to perform, mutatis mutandis, analogous functionality to that described above.

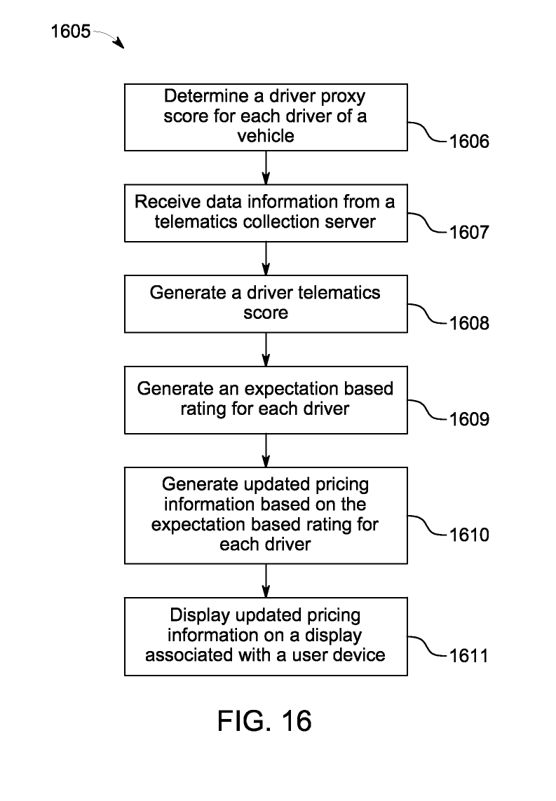

FIG. 16 shows another flow diagram for a method 1605 for expectation based processing. In the method 1605 shown in FIG. 16, the system 100 determines a driver proxy score for each driver associated with a vehicle 140 step 1606). The driver proxy score may be based on demographic information provided by the driver or it may be based on previous data regarding the driver (for example, from recorded data the previous year). The system 100 may then receive telematics data from a telematics collection server (step 1607). For example, the telematics collection server may be the DCU 110. This telematics collection server may be operated by a third party vendor or by the insurance company or any suitable party. This information may be formatted and electronically transmitted to the DPU 170. The DPU 170 may use a software based algorithm to determine a driver telematics score for each driver (step 1608). The DPU 170 may then determine an expectation based rating for each driver (step 1609). The RPU 160 may be configured to use a multivariate analysis to generate updated pricing information (step 1610). This information may be determined on an individual telematics factor basis. The system 100 may format this information and then display it to the display of a user device 130 (step 1611). The display may indicate specific factors on which a credit or penalty was assessed and an overall presentation of driving behavior. The display may further provide the user with a graph showing the driver's behavior versus the expectation as well as the hypothetical baseline driver. The system 100 may further be configured to provide the display with information regarding suggested changes to driving behavior which may save the driver money.

The system 100 may provide this information at a predetermined renewal period or based on a triggering event. A triggering event may occur, for example based on the variance of the telematics data to an expected value or any event or observed data that may adjust expected losses.

The system 100 may further include a user transmission device (not pictured) wherein the user transmission device may communicate insurance information, including pricing information, contractual information, information related to the telematics program, and other notifications. A user transmission device may include one or more modes of communication to reach a potential customer, current customer, or past customer or other similar user. For example, the user transmission device may be coupled with a printing device that is automatically mailed to the user. In another embodiment, the user transmission device may be coupled to a device to generate automatic telephone calls, or “robo-calls,” or other similar communication mediums to communicate with the user. The user transmission device may further be configured to send e-mails to a user. The user device may further be configured to communicate via social media. This information may include, in addition to pricing information, an itemized list indicating a variance from the expected value for each risk factor, suggested driving behaviors etc.

The multivariate predictive model(s) used herein may include one or more of neural networks, Bayesian networks (such as Hidden Markov models), expert systems, decision trees, collections of decision trees, support vector machines, or other systems known in the art for addressing problems with large numbers of variables. In embodiments, the predictive models are trained on prior data and outcomes using an historical database of insurance related data and resulting correlations relating to a same user, different users, or a combination of a same and different users. In embodiments of the present invention, the predictive model may be implemented as part of the DPU 170 or RPU 160 described with respect to FIG. 1.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or BLU-RAY Disc, or other type of device for electronic data storage.

Although the methods and features described above with reference to FIGS. 2-16 are described above as performed using the example architecture 100 of FIG. 1, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-16 may be used alone without the other features and elements or in various combinations with or without other features and elements. Sub-elements of the methods and features described above with reference to FIGS. 1-16 may be performed in any arbitrary order (including concurrently), in any combination or sub-combination.

1. A system for determining insurance pricing information based on telematics data associated with a vehicle, the system comprising:
a computer memory configured to store an initial risk profile for a driver of the vehicle based on a correlation between received biographical information of the driver and stored claim expected loss information, wherein the initial risk profile includes a plurality of risk factors with associated expected scores for the driver;
a processor configured to generate a driver proxy score (DPS) based on a combination of rating variables in an insurance class plan;
the processor, configured to receive information associated with telematics data received from a telematics device, wherein the telematics data includes data associated with a plurality of risk factors;
the processor further configured to determine a driver telematics score (DTS) based on the information associated with the telematics data;
the processor further configured to generate an expectation based rating, based on the DPS and the DTS, which measures a variance of the received telematics data information from the initial risk profile;
the processor further configured to update pricing information based on the generated expectation based rating; and
a transmitter configured to transmit the updated pricing information to a user device or a user transmission device.

2. The system of claim 1, wherein at least one of the plurality of risk factors is total miles driven.

3. The system of claim 1, wherein at least one of the plurality of risk factors is speeding.

4. The system of claim 3, wherein speeding is measured relative to posted speed limits.

5. The system of claim 3, wherein speeding is measured relative to other vehicles travelling a route during similar times of day.

6. The system of claim 1, wherein the processor is further configured to provide a customer with an itemized list indicating a variance from the expected value for each risk factor.

7. The system of claim 1, wherein during a renewal period, the processor sets the measured values as the initial risk profile.

8. The system of claim 1, wherein at least one of the plurality of risk factors is cell phone use.

9. The system of claim 1, wherein at least one of the plurality of risk factors is driving at a predetermined time.

10. A computer based method for determining insurance pricing information based on telematics data associated with a vehicle, the method comprising:
storing, by a computer memory, an initial risk profile for a driver of the vehicle based on a correlation between received biographical information of the driver and claim expected loss information, wherein the initial risk profile includes a plurality of risk factors and with associated expected scores for the driver;
generating, by a processor, a driver proxy score (DPS) based on a combination of rating variables in an insurance class plan;
receiving, by the processor, information associated with telematics data received from a telematics device, wherein the telematics data includes data associated with a plurality of risk factors;
determining, by the processor, a driver telematics score (DTS) based on the information associated with the telematics data;
generating, by the processor, an expectation based rating, based on the DPS and the DTS, which measures a variance of the received telematics data information from the initial risk profile;
updating, by the processor, pricing information based on the generated expectation based rating; and
transmitting, by a transmitter, updated pricing information to a user device or a user transmission device.

11. The method of claim 10, wherein the pricing information is adjusted during a renewal period.

12. The method of claim 10, further comprising initiating an adjustment of pricing information outside of a renewal period if the variance of the telematics data from the expected value exceeds a threshold.

13. The method of claim 10, further comprising displaying the updated pricing information on a display associated with the user device.

14. The method of claim 10, further comprising initiating an adjustment of pricing information based on the addition of another a vehicle.

15. The method of claim 10, wherein at least one of the plurality of risk factors is total miles driven.

16. The method of claim 10, wherein at least one of the plurality of risk factors is speeding.

17. The method of claim 16, wherein speeding is measured relative to posted speed limits.

18. The method of claim 16, wherein speeding is measured relative to other vehicles travelling a route during similar times of day.

19. A system for determining insurance pricing information based on telematics data associated with a vehicle, the system comprising:
a computer memory configured to store an initial risk profile for a driver of the vehicle based on an insurance class plan responsive at least in part to expected claim loss information, wherein the class plan is based on a plurality of risk factors with associated expected scores for the driver;
a processor configured to generate at least one driver proxy risk factor score based on the insurance class plan;
the processor, configured to receive information associated with telematics data received from a telematics device, wherein the telematics data includes data associated with at least one of the risk factors in the class plan;
the processor further configured to generate an expectation based rating, responsive to the at least one driver proxy risk factor score and the telematics data information, which measures a variance of the received telematics data information associated with the at least one risk factor from the class plan expected risk factor scores; and
the processor further configured to update pricing information based on the generated expectation based rating.

20. The system of claim 19, wherein at least one of the plurality of risk factors is one of total miles driven, speeding and time of day.
